(19) United States
(12) Patent Application Publication
(10) Pub. No.: US 2013/0088013 A1
(43) Pub. Date: Apr. 11, 2013

(54) Water current energy converter system

(71) Applicants: Moshe J. Yan, Highland Park, NJ (US); Weifan Yan, Highland Park, NJ (US)

(72) Inventors: Moshe J. Yan, Highland Park, NJ (US); Weifan Yan, Highland Park, NJ (US)

(21) Appl. No.: 13/317,129

(22) Filed: Oct. 11, 2011

(51) Int. Cl. F03B 13/10

(52) U.S. Cl. 290/54

(57) ABSTRACT

Apparatus for converting the energy present in water currents into electrical energy includes a rotatable central shaft a portion which is submerged below the surface of a body of water. A multiplicity of curved, horn shaped, devices responsive to water currents are connected via arms to the central shaft and cause the arms and the shaft to rotate and drive an electrical generator to produce an electrical output. The central shaft may be coupled to an electrical generator located above the water level to permit the easy and reliable maintenance of the apparatus. Alternatively, the central shaft may be coupled to a submersible electric generator or may extend horizontally parallel to the floor of the body of water.

### BACKGROUND OF THE INVENTION

The present disclosure relates to apparatus and mechanisms for converting energy present in flowing water currents into electrical energy.

There is a global and urgent need for alternative sources of energy to reduce dependence on foreign oil. Solar energy and wind energy systems have found extensive usage. However, they suffer from the fact that they are intermittent. The sun does not always shine and the wind does not always blow. As a result, power (utility) companies cannot rely on a steady source of electricity from these sources of energy and must therefore purchase and maintain equipment to supplement periods of blackout.

In contrast, the water flow of rivers is, for all practical purposes, steady and constant. Presently, most of the hydroelectric power stations in the world rely on the building of dams in order to take advantage of the huge source of energy in a compact space. However, this approach not only requires a large investment for the cost of the construction of the dams, but also causes great ecological and environmental damage around the power station area. It is therefore desirable, in many instances, to have different systems and apparatus for converting water flow into electrical energy.

Many different types of systems for converting the current flow of rivers and oceans into useful mechanical power which can then be converted into electric power have been suggested. However, the systems known to Applicants have certain drawbacks in that they tend to be inefficient, are limited in scope and breadth and are difficult to install and/or maintain. Also, some drawbacks of known systems is that they can cause severe damage to any living organism (fish) that is impacted by them during normal operation and they themselves are easily damaged due to being impacted by foreign objects. This results in substantial maintenance cost with no additional benefit. Other drawbacks is that known technologies may not be scalable, are limited in how and where they are placed and do not enable the easy servicing of critical parts.

Applicants' invention is directed to systems and apparatus which overcome the problems discussed above.

### SUMMARY OF THE INVENTION

In accordance with one aspect of the invention, the energy present in water currents is used to cause the rotation of a central shaft, which extends below the water level. The submerged portion of the central shaft is connected to curved horn shaped propellers which cause the central shaft to rotate in response to the water current flow. The rotatable central shaft may be positioned so it extends in the vertical direction or in the horizontal direction. In either position, the rotatable central shaft driven by the curved horn shaped devices is coupled to and drives an electric generator to produce electrical energy.

In some embodiments, the electric generator may be a waterproof submersible device and be coupled to a submerged portion of the rotatable central shaft. In other embodiments, the electric generator is connected to a portion of the rotatable central shaft which extends vertically above the water level, whereby the electricity generating apparatus is generally not in contact with, and not affected by, the water. Using a portion of the central shaft located above the water level to drive an electrical generator, which is also located above the water level, permits the easy and reliable maintenance of the mechanical to electric conversion apparatus.

Water current energy converter systems embodying the invention include a multiplicity of arms attached to the submerged portion of the central shaft. The arms extend in a generally perpendicular direction relative to the central shaft. Propellers which may be curved horn shaped devices are attached to the arms. Each horn shaped device includes a large open input end to receive and capture water current flow and an open output end out of which water flows; where the output end has an area which is a small fraction of the area of the input end. The horn shaped device is operated as an “inverted” horn responsive to water current to “push” or urge the horn, and the arm attached to it, to move. Thus, the “inverted” horn shaped devices are designed to be responsive to current flow and to cause the arms and the central shaft, attached to the arms to rotate (in a clockwise or counter clockwise direction). The motion of the horns and the arms is in a generally circular direction, generally perpendicular to the axis of rotation of the central shaft. This apparatus thus converts linear flowing water currents into rotary motion and causes the central shaft to rotate. The central shaft is, in turn, coupled (directly or indirectly) via suitable mechanical apparatus (e.g., gears, belts or pulleys) to an electrical generator to produce an electrical output.

In accordance with a still other aspect of the invention, the apparatus for converting linear flowing water currents into rotary mechanical motion may be mounted along piers, wharfs, boats or any like structure. The apparatus may be mounted on a frame attached to these structures. Alternately, the apparatus may be mounted to rest on the bottom of the body of water so long as the central shaft is free to rotate.

Systems and apparatus embodying the invention can be manufactured and deployed to deliver significant amounts of low-cost electrical energy.

### BRIEF DESCRIPTION OF THE DRAWINGS

In the accompanying drawings, which are not drawn to scale, and which are provided for purpose of illustration only, like reference characters denote like components: and

FIG. 1 is a highly simplified isometric view of a water current energy converter embodying the invention;

FIGS. 1A, 1B, 1C and 1D are highly simplified cross sectional diagrams of various water current flow energy converter systems embodying the invention;

FIG. 1E is a highly simplified isometric view of an embodiment of the invention

FIG. 2 is a highly simplified cross-sectional view of an “inverted” curved horn shaped propeller device embodying the invention suitable for capturing flowing water and causing rotation of a central shaft;

FIGS. 2A and B are highly simplified different cross-sectional views of the inverted horn (modified funnel) shaped propeller of FIG. 2;

FIGS. 3A, 3B, and 3C are different views of another inverted curved horn shaped propeller device embodying the invention suitable for capturing flowing water and causing rotation of a central shaft;

FIG. 4A is a simplified top view of 4 “inverted” horn (funnel) shaped devices embodying the invention arranged to rotate in a horizontal plane and to cause the central vertical shaft to rotate;

FIG. 4B is a simplified top view of multiple curved horn (funnel) shaped devices embodying the invention arranged to rotate in a horizontal plane and to cause the central vertical shaft to rotate;

FIG. 5 is a simplified drawing showing a hybrid system in which a water flow driven system and a wind responsive system are combined to produce electric power;

FIG. 6 is a highly simplified isometric diagram showing the use of multiple converters and electric generators combined to produce a single output;

FIG. 7 is a highly simplified isometric diagram showing the location of converters and electric generators embodying the invention about the arches of bridges to get the benefit of enhanced current flow;

FIG. 8 is a highly simplified isometric diagram showing the central shaft of a water flow converter supported from a point on the river bed;

FIG. 9 is a highly simplified isometric diagram showing a fully submerged water current flow converter with a vertically oriented shaft driving an electrical generator; and

FIG. 10 is a is a highly simplified diagram showing a fully submerged water current flow converter driving an electrical generator; where the central shaft extends horizontally, parallel, to the river bed.

### DETAILED DESCRIPTION OF THE DRAWINGS

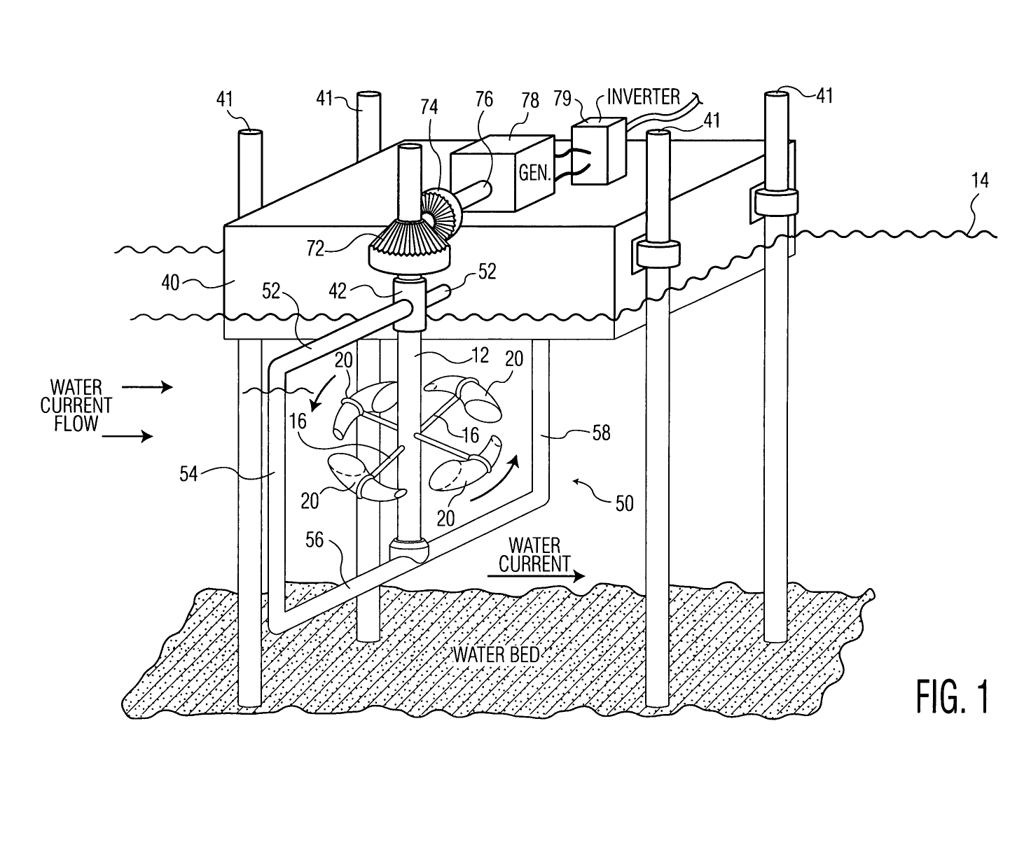

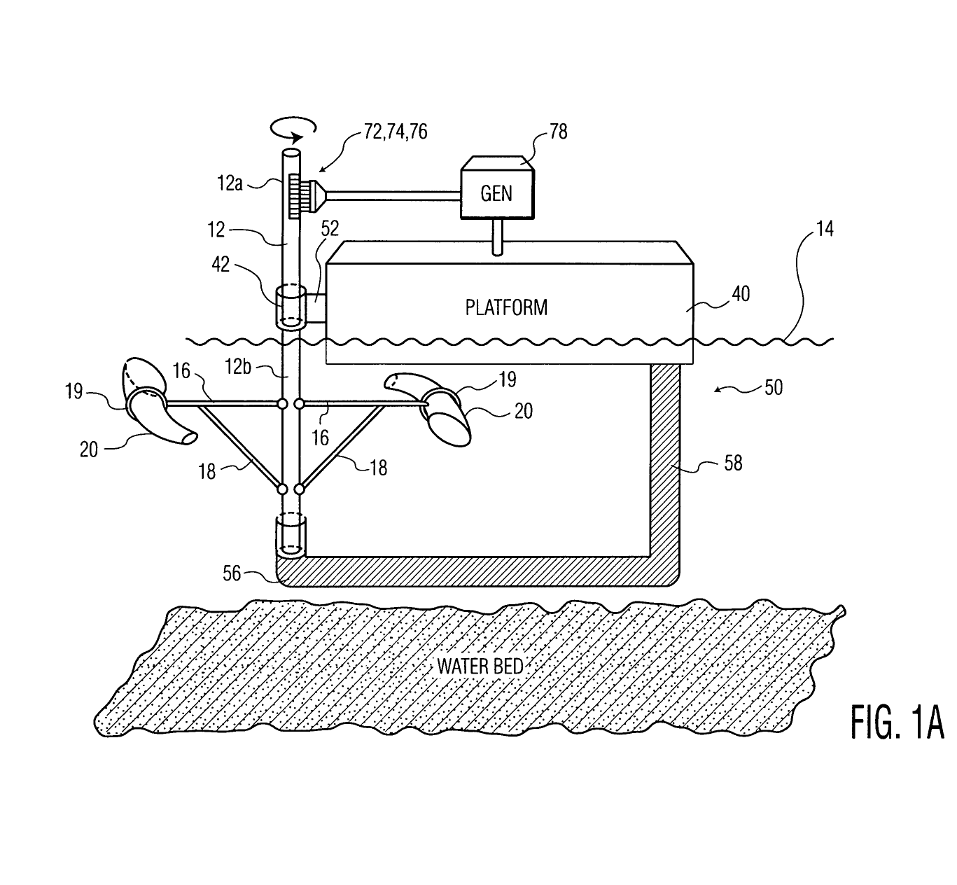

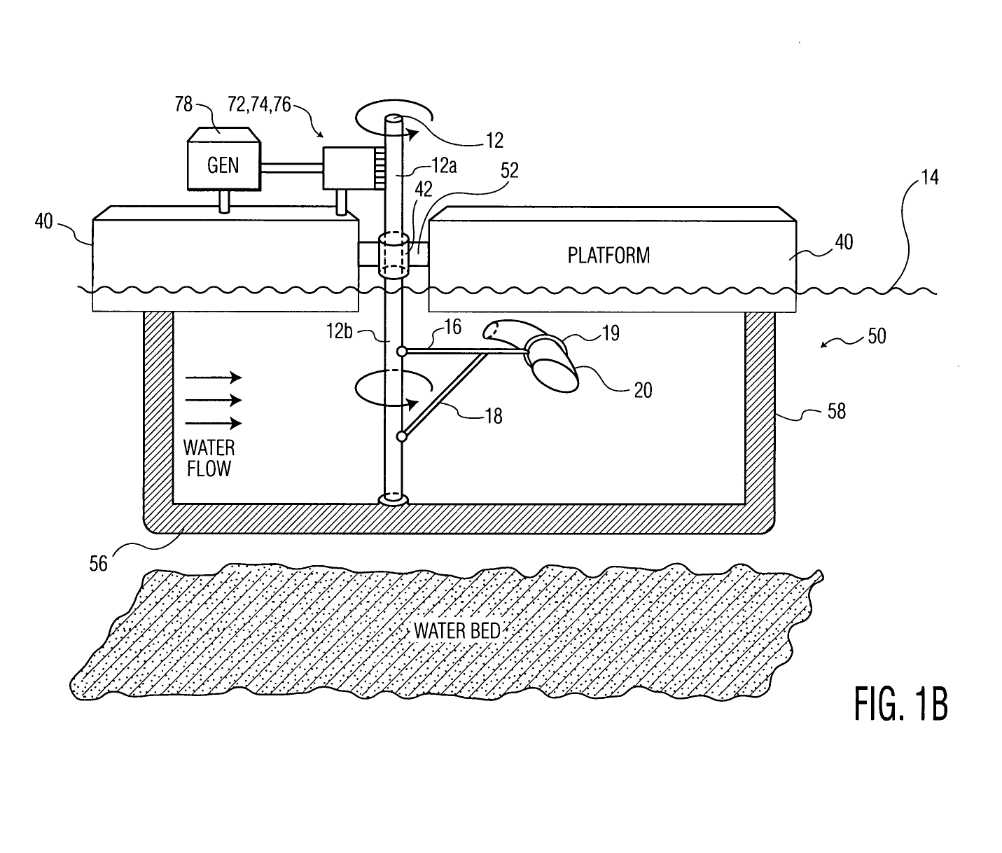

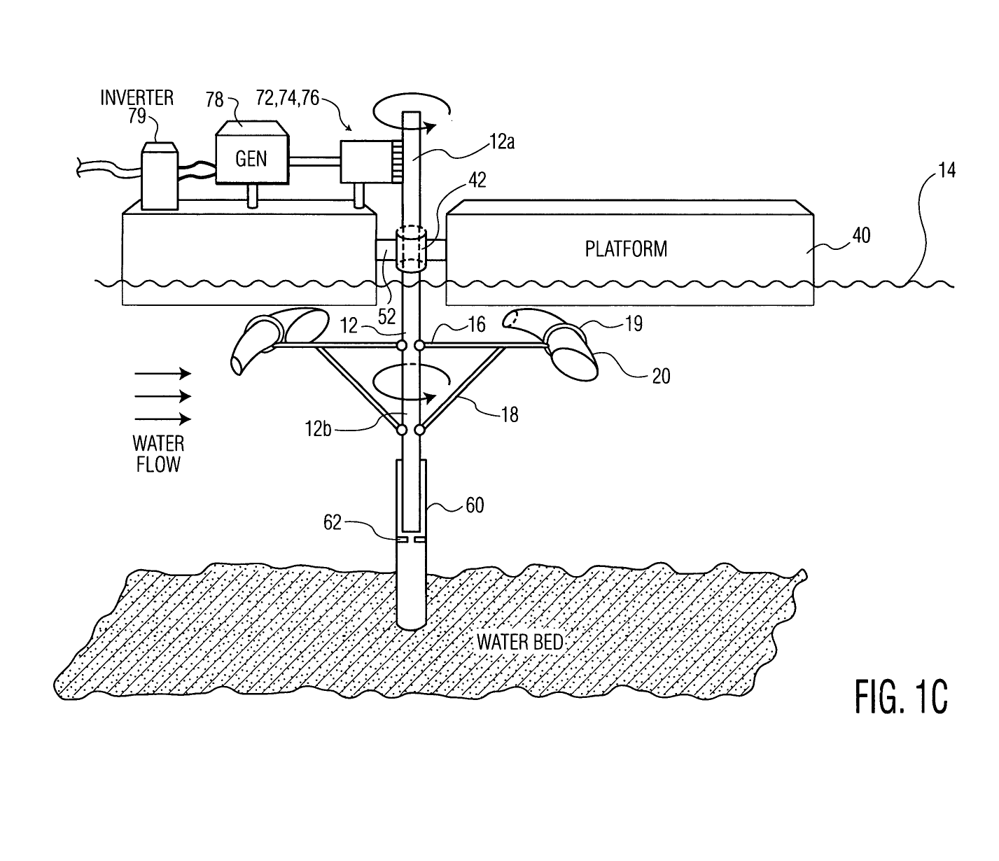

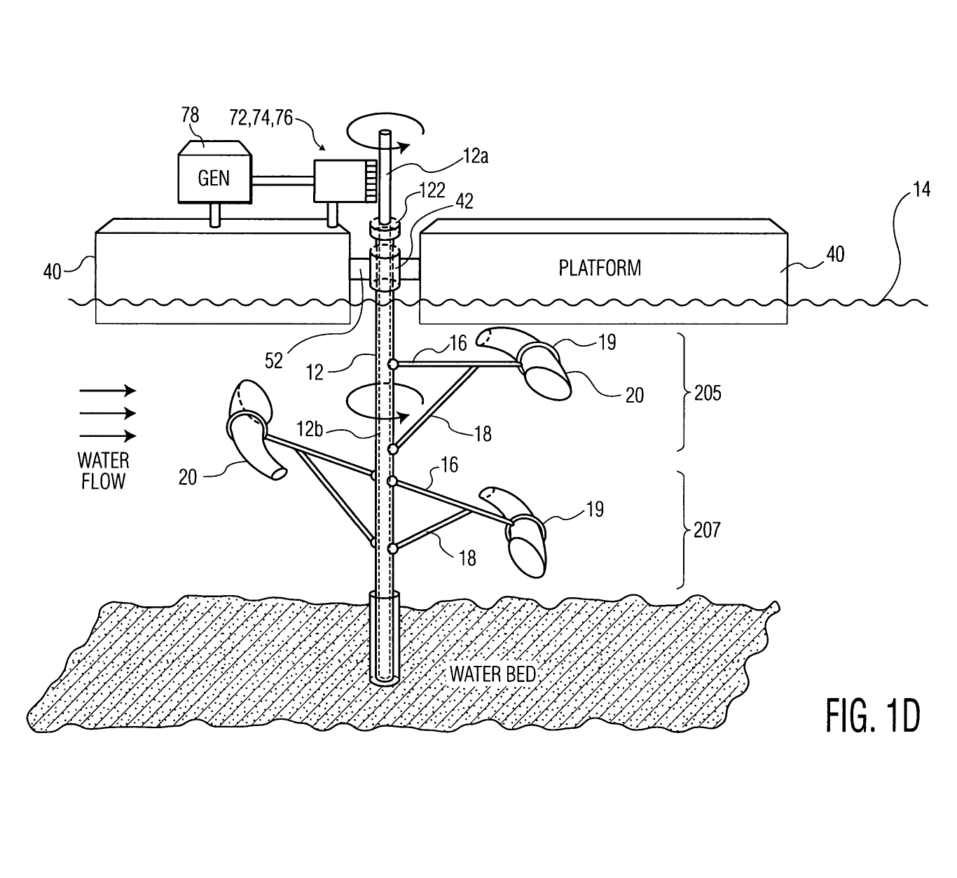

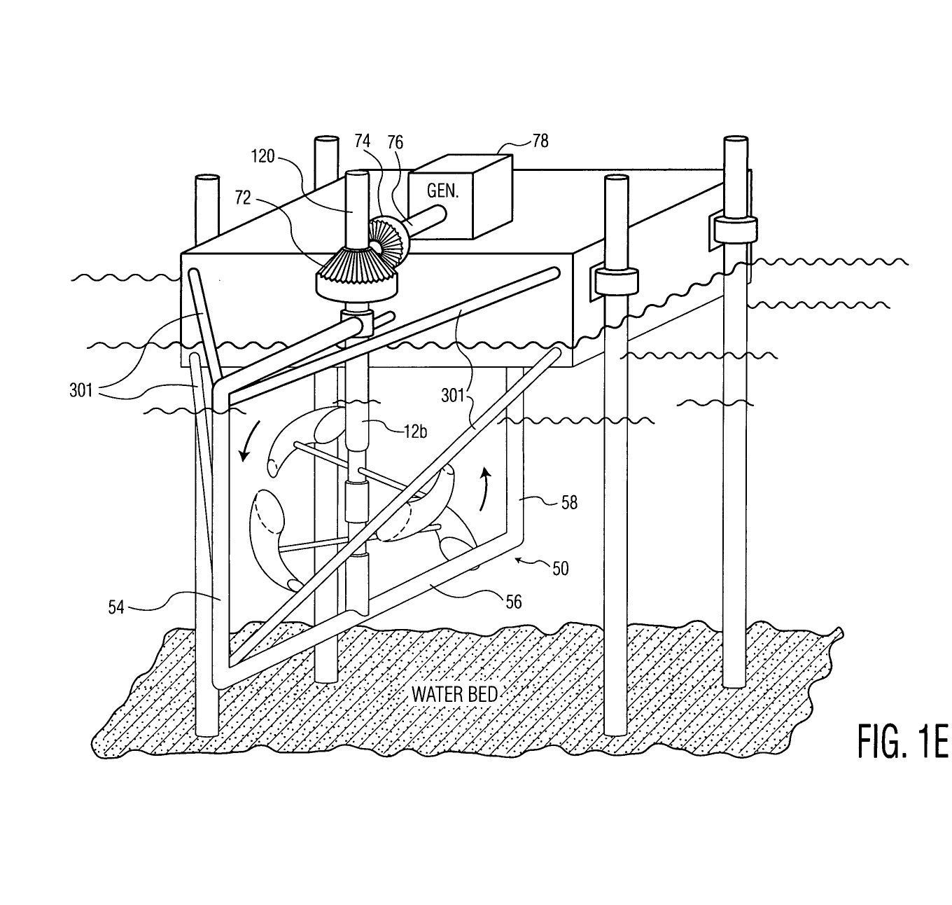

Referring to FIGS. 1, 1A, 1B, 1C 1D, and 1E there is shown a rotatable central shaft 12, having a portion 12a generally above the water level and having a portion 12b generally submerged below the water level 14. A multiplicity of arms 16 are attached at their proximal (inner) ends to the central shaft 12b. The arms 16 extend in a generally perpendicular direction away from the central shaft. At their distal end the arms 16 are connected to propellers 20 which are designed to rotate in a generally circular pattern (e.g., horizontally, like a carousel or horizontal water wheel, in these figures) in response to the water current flow and which, in turn, cause the central shaft 12 to rotate.

In FIGS. 1, 1A, 1B, 1C, 1D and 1E, the central shaft 12 is attached to a platform 40 such that the central shaft 12 is maintained and held in a generally vertical orientation, perpendicular to the river bed. Platform 40 may be a pier, barge, boat, wharf, raft or the like. The central shaft 12 is held in place, a fixed distance from the platform, but is so connected to the platform that it is free to rotate in response to the water current flow driving the propellers 20 and their corresponding arms 16. The portion of the central shaft 12a which extends above the water level is shown connected to a gear arrangement 72 which engages another gear system 74 which drives, via a shaft 76, an electric generator 78 which is fixedly mounted above the platform 40. Thus, the portion of the central shaft, 12a, extending above the water level and/or above the top surface of the platform, is connected to a gear system 72 which in turn meshes with a gear system 74 to which is attached a shaft 76 driving an electrical generator 78 for producing electric power in response to the movement of the devices 20 causing central shaft 12 to rotate. The gear systems are shown for illustrative purposes only and any other equivalent mechanical means such as belts and/or pulleys may be used.

It is significant that, in these embodiments of the invention, the generator 78 and any other electrical or electronic equipment (such as an inverter 79 which can be connected via a cable into a power utility grid or an energy storage system) are generally located above the water level so they are not in contact with the water. This makes the system and its operation much more reliable and also ensures that these components can be easily maintained and/or replaced, if need be. The electrical generator 78 is shown in FIG. 1 resting on a top surface of platform 40 which serves to keep the electrical generator 78 out of the water. The platform 40 may be floating or be secured to the river bed via support poles 41 or to another structure (not shown) such as a pier or wharf.

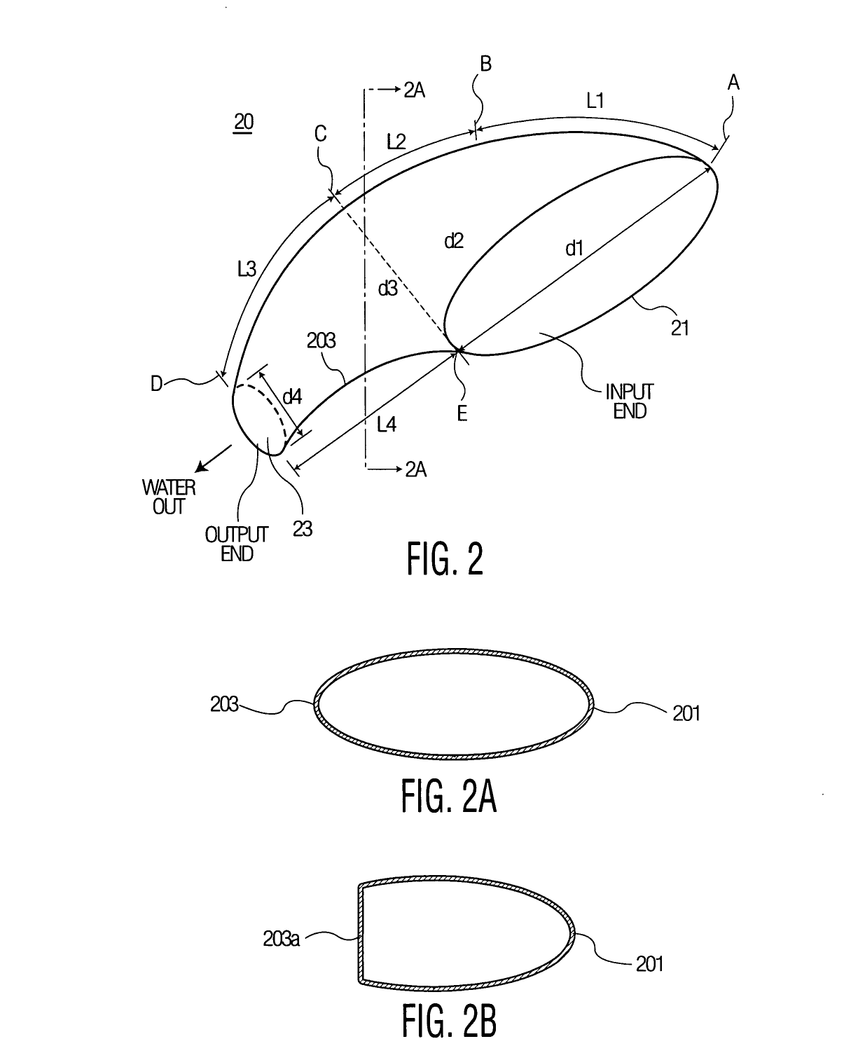

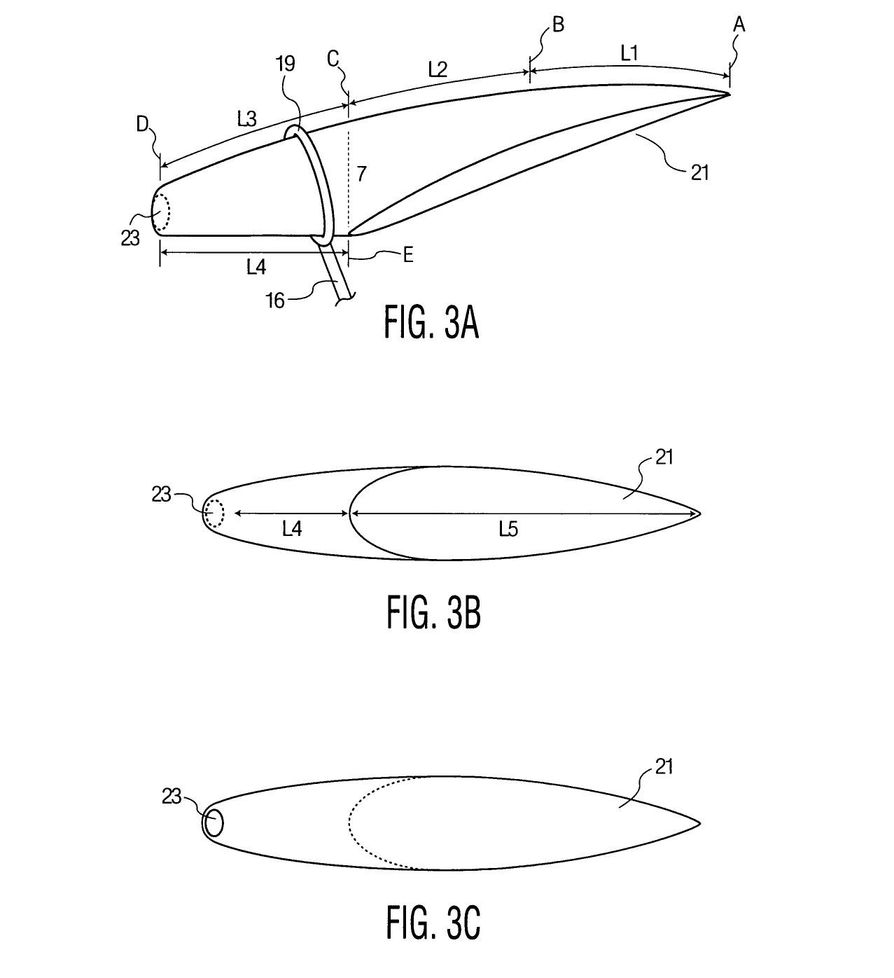

The propellers 20 mounted on arms 16 are shaped to capture and convert the force of the water flow into mechanical (e.g., rotational) motion and may have any shape which is suitable for this purpose. In the figures the propellers or water current flow responsive devices 20 are shown to have a shape generally similar to an “inverted” curved horn, trumpet or “shofar” (i.e., a curved ram's horn). As illustrated in FIGS. 2, 2A, and 2B and in FIGS. 3A-3D, each propeller device 20 has a large open input end, area 21, which is designed to present a relatively large area into which water can flow and urge the device 20 to rotate. The input end 21 may have a shape produced by cutting the base of a cone at an angle (obliquely) producing a pocket which, when facing the water current, can capture water current which then flows into and through it. The device 20 has an “open” output end 23, through which the water flows out and whose area is small compared to the area of the input end 21. The input end 21 and the output end 23 may face in different directions such that the water flowing into the device 20 along one direction exits from the device in a different direction and at an angle thereto. In FIG. 2, the device 20 is shown to be a curved horn, along its length, going from the output to the input. The cross section of the horn-like device and its outer edge is also shaped to cut through the water with a minimum of resistance to ensure that the efficiency of the system is optimized, as illustrated in FIGS. 2A and 2B and in FIGS. 3A-3C.

The (“inverted”) curved horn shaped devices 20 are specifically designed to operate in flowing water currents such as those found in natural or man-made waterways (e.g., rivers, oceans, canals). The devices 20 are completely submerged beneath the surface 14 in a manner to convert the linear motion of flowing water current into rotary motion through the use of horizontally (or vertically) positioned arms attached to the central shaft which rotates in response to the torque developed by the horn shaped devices attached to the arms.

In FIG. 2, the outer edge 201 of device 20 (defined by lines L1, L2 and L3, extending from points A to B to C and to D) describes a broad arc for hydrodynamic consideration. Alternatively, note that this outer edge can be nearly a straight line (as shown in FIG. 3A). The inner edge 203 of device 20, defined by line L4, going from the output end (plane D) to point E may also present a curved surface (as shown in FIG. 2) or it may be a straight line (as shown in FIG. 3A). The output end portion of device 20 (extending from point C to plane D and point E) is, as shown, of generally conical shape. For ease of illustration, the opening 21 (which need not be circular) is shown to have a diameter d1. The output end of device 20 may be assumed to be generally cone-like (extending from C to D and to E) having a base with a diameter d3. The open output end 23 which may be circular, oblong or have any other suitable shape, is shown to have a diameter d4. The length of L1 may be from less than 2 to more than 15 times the length of (L2+L3). The diameter d3 at the base of the cone (CDE) may be from less than 2 to more than 15 times the diameter d1. The overall length of device 20 (L1 plus L2 plus L3) may range from under one foot to several feet.

Applicants have found that making propelling device 20 with a large open input end and a small opening at its output 23 provides greater thrust and a more responsive horizontal and rotational movement. The area of the output opening 23 is preferably a small ratio of the area of the input end 21. The input end 21 functions like a “funnel” but is generally shaped more like the base of a cone which has been cut at an angle (obliquely). The exact shape may be selected to be circular or oblong and/or any suitable shape as shown in FIGS. 2, 2A, 2B and 3A through 3C.

In one embodiment, the area of input end 21 was made 7 times the area of the output end 23. The small open end 23 functions to allow water to flow out with a thrust out causing a turbulence effect in front of the propeller. When the propeller moves forward, there is less resistance to its forward movement. Thus, propellers embodying the invention may be described as being generally (inverted) curved horn shaped devices having a significantly large area at their input end facing the water current flow for capturing water flow and having a small opening (small area) at their output end for the water to flow out.

FIG. 2A shows an embodiment of propeller 20 where the cross section of the propeller taken between the inner edge 203 and the outer edge 201 is highly symmetrical (elliptical and/or fish like).

FIG. 2B shows an embodiment of propeller 20 where the cross section of the propeller taken between the inner edge 203 and the outer edge 201 is shaped such that the inner edge 203a (inner side of the propeller 20) provides a surface or edge which is generally perpendicular to current flow so the water will tend push the propeller along the inner edge. The outer edge 201 may be shaped like that of FIG. 2A.

FIGS. 3A, 3B and 3C are variations on the shape of the propeller discussed for FIGS. 2, 2A and 2B. The input pocket 21 is more like paddle or a catcher's mitt and provides a potentially larger water receiving surface than that shown in FIG. 2. This embodiment illustrates that there may be significant variations in the shape of the propellers embodying the invention. FIGS. 3B and 3C are bottom and top views of the device 20 illustrating the structure of the device to capture water current flow. As shown in FIG. 3A every propeller 20 has an attachment means (such as 19) to connect the propeller to an arm 16. Theoretically, the horns could be directly connected to the central shaft. But, connecting the horns to arms provides greater thrust and ease of design.

The angular positioning of devices 20 relative to the direction of water flow may also be adjusted by the rotation of arms 16 and/or by rotating the devices 20 about their arms 16 to provide matching for the angle of water current flow and to try to optimize the response of the system to the force of the water.

The arms 16 may be made of stainless steel and the propellers may be made of stainless steel, aluminum and even plastic.

The vertical central shaft 12, the arms 16 and the propelling devices 20 which are designed to cause the rotation of the shaft 12 may be referred to as a linear water current flow to rotary converter.

The devices 20 are firmly and fixedly attached to their respective arms 16 via holding apparatus 19. The devices 20 are supported by arms 16 which may be reinforced by truss (struts) arms 18 extending from the shaft 12b to arms 16, as shown in FIGS. 1A, 1B, 1C, and 1D. The arms 16, which extend like a cantilever, may be subjected to bending and or twisting. The bracing diagonal struts 18 tend to maintain the arms steady particularly when pressure from water current causes forces to be applied to the arms at different angles. The length of the arms 16 is a function, in part, of the available width of the water channel and of the shape of any frame formed to hold the power generation system.

In FIGS. 1 and 1A the central shaft 12 is attached to an external wall of a platform 40. Platform 40 may be a pier, wharf, boat or raft or any like structure. Support apparatus is provided to maintain the vertical orientation of the central shaft and its spatial relationship to the platform. A collar 42 (with bearings, not shown) is positioned around the central shaft 12 and piping 52 is connected between the collar and the platform to hold the central shaft in place. Piping 52 is part of a frame assembly 50 which depends from platform 40 to support and hold the central shaft 12 and the rotating “water wheel” assembly in place. The frame 50 includes horizontal members 52 and 56 interconnected with vertical members 54 and 58 to hold the central shaft 12 in place. Bearings (not shown) are provided so the central shaft 12 is free to rotate. The frame assembly 50 holds the central shaft 12 and associated arms 16 and propellers 20 in a fixed relationship to the platform 40. Thus, as the platform moves up and down with the water level so does the entire converter assembly. Consequently, as shown in the Figures the shaft 12 can drive electric generator 78 without the generator making contact with the water.

FIGS. 1B and 1C illustrate that the central shaft 12 can be positioned so as to extend through an appropriate hole/space within platform 40. FIG. 1B shows the central shaft 12 mounted within a central space or between inner wall(s) of platform 40. The structure and operation of the converter are similar to those of FIGS. 1 and 1A.

FIG. 1C shows the bottom part of central shaft 12b extending within a sleeve 60 attached to the water bed. The shaft 12 is mounted within the sleeve 60 and rests on a stop 62 so the shaft is supported while being free to rotate freely. The significance of this structure is that the frame 50 can be eliminated. This removes a limitation (present in FIGS. 1, 1A and 1B) on the length that the arms 16 can extend due to the support structure. Making the arms 16 longer is desirable as it provides more toques and increase the amount of force produced.

FIG. 1D shows that the central shaft 12 may be positioned and held in a vertical orientation via collar 42 with stops 122 extending from the shaft 12 to maintain the shaft stops above collar 42 and preventing the shaft from moving down vertically. That is, it avoids the need for having stops such as 62 of FIG. 1C. Additional apparatus including bearings (not shown) may be provided to ensure that the central shaft remains at a fixed distance relative to the wall(s) of the platform while being free to rotate. The structure of FIG. 1D, like that of FIG. 1C, may eliminate the need for support structure 50 and remove a limitation on the length of arms 16. FIG. 1D also shows two sets of propeller assemblies 205, 207, one stacked above the other. This is by way of example only and there could be more than two sets depending on the depth of the water and the number and size of the propellers.

FIG. 1E shows the use of additional cross bars 301 connected between the platform 40 and members of the support structure to reinforce the support structure and hold the central shaft in place. This figure also shows that two sets of propeller assemblies, one stacked atop the other, are, and can be, mounted along the submerged portion of shaft 12b.

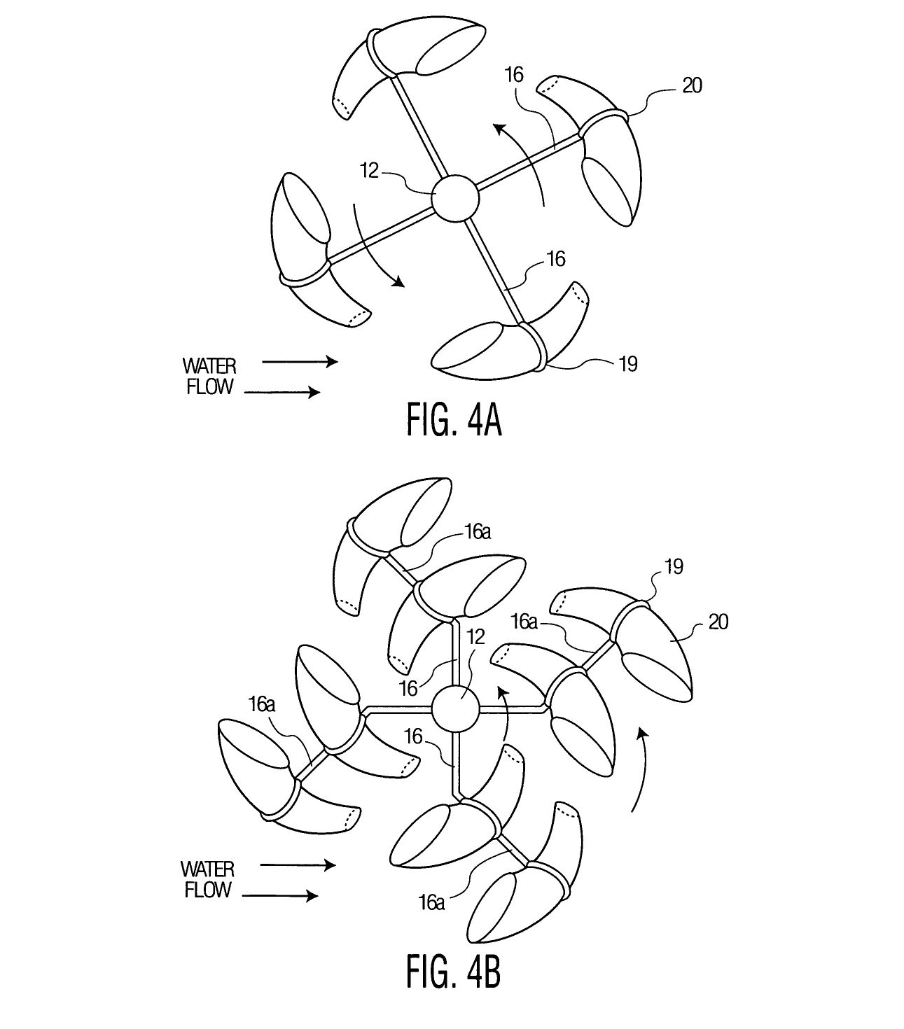

FIG. 4A shows a top view of four (4) curved horn shaped propellers 20 tethered via holders 19 to the distal end of arms 16. The interior ends of arms 16 are connected to the central shaft 12 to cause it to rotate in a circular direction. For the central shaft 12 oriented vertically, the arms 16 and the propellers 20 rotate in a horizontal circular plane parallel to the river bed. When the central shaft is oriented horizontally (as shown in FIG. 10) the arms 16 and the propellers 20 rotate in a circular plane perpendicular to the river bed. In both instances the rotation is perpendicular to the orientation of the central shaft.

FIG. 4B shows propellers 20 attached to the arms 16 and to arms 16a, extending from arms 16, to increase the density of the propellers and therefore to increase the rotational forces being developed and applied to the central shaft 12. FIG. 4B is another embodiment illustrating apparatus arranged to rotate in a horizontal plane (for the vertical orientation of the central shaft) and to cause the central vertical shaft to rotate. The arms 16a may extend in line with arms 16 (in which case it would be equivalent to have 2, or more, propellers along an arm) or be at any angle relative to the direction of arm 16. This enables obtaining more force energy from water while saving space.

The water current flow energy converter (WCFEC) may be configured to rotate in either direction (clock-wise or counter clock-wise). It will continue to rotate in that direction so long as current continues to flow in the same direction.

The distance from the point at which an arm is attached to the central shaft until the point where a device 20 is attached determines the amount of torque that can be developed. The force (and speed) of the current flow applied to device 20 determines the available force and the amount of torque that can be developed and the amount of mechanical force available to cause the central shaft to rotate.

The shape and input surface area 21 of devices 20 can be varied from what is shown in the drawings but still be within the ambit of the invention. One or more propeller devices 20 may be attached to the distal end of the arms or at any desired point along the length of the arm or any arm extension. As already noted the devices 20 are used to capture current flow energy and develop the mechanical power which causes the central shaft 12 to rotate. The devices 20 may be attached to the arms in any manner which ensures that they remain fixedly connected to their respective arms.

The water flow energy converter may be located in a river adjacent to any electrical power generation station which is on shore or offshore so the converter's electric output can be coupled thereto. Thus, the electrical generator 78 may produce an output which can be fed via an inverter 79 to a local power grid or to any storage device (not shown). Systems embodying the invention can be set up at selected distances along a river (e.g., every 100 feet).

The system is easy to maintain and the generator (turbine) only needs a small area. A large number of layers of sets of propellers can be installed depending on water level and the speed of the flow. The sets of the propellers can be put on at many different angles.

The dam-free hydropower equipment of the invention is placed within the river space to capture the kinetic energy of the river water flow as it “falls” from a higher elevation to a lower elevation by the pull of gravity.

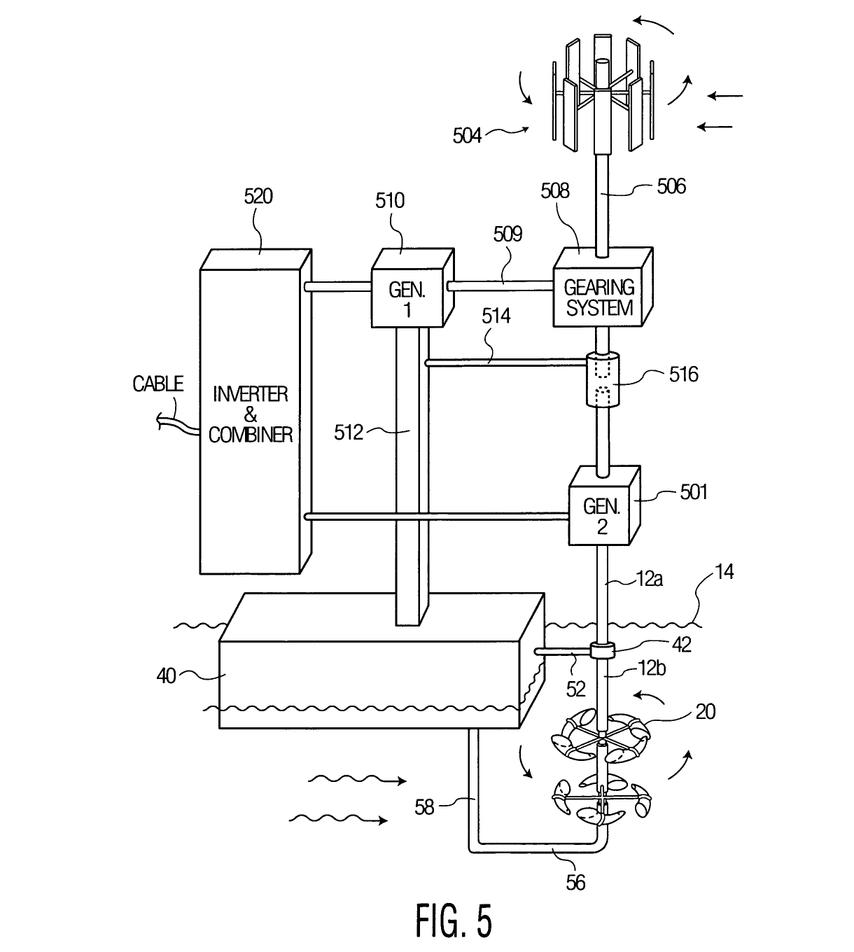

FIG. 5 is a simplified drawing showing a hybrid system in which a water flow driven system and a wind responsive system are combined to produce electric power. In FIG. 5, the central shaft 12 may be attached to a platform 40 and supported in any of the ways discussed above. The submerged portion 12b of central shaft 12 is driven and caused to rotate by propellers 20. The above water level portion 12a of central shaft 12 drives an electric generator 501. The generator 501 may be driven directly or indirectly from shaft 12a.

In FIG. 5 there is also shown a wind responsive vane 504 which drives a shaft 506 which is coupled via a mechanical translator 508 and shaft 509 to an electric generator 510. The wind responsive system may be supported by a support system (512, 514, 516) depending from the platform 40. The outputs of generators 501 and 510 may be combined in a combiner and inverter 520 to produce a combined electrical output fed by a cable.

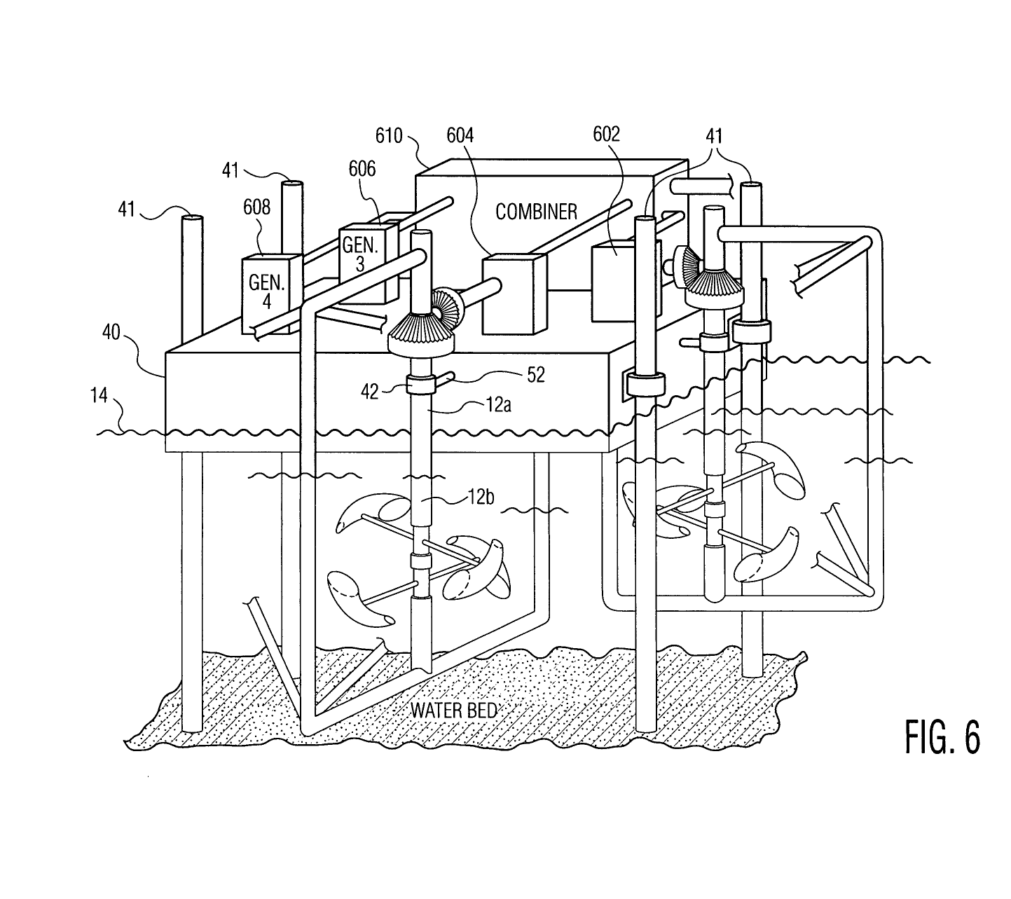

FIG. 6 is a highly simplified isometric diagram which shows that a multiplicity of water flow to electric energy converters, which may be of the type describe above, can be attached to and supported by a platform 40. The different converters can drive their respective electric generators. For purpose of illustration, FIG. 6 shows four (4) electric generators 602, 604, 606 and 608. It is also shown that the varied outputs of the generators can be coupled to a combiner 610 to produce a common electrical output.

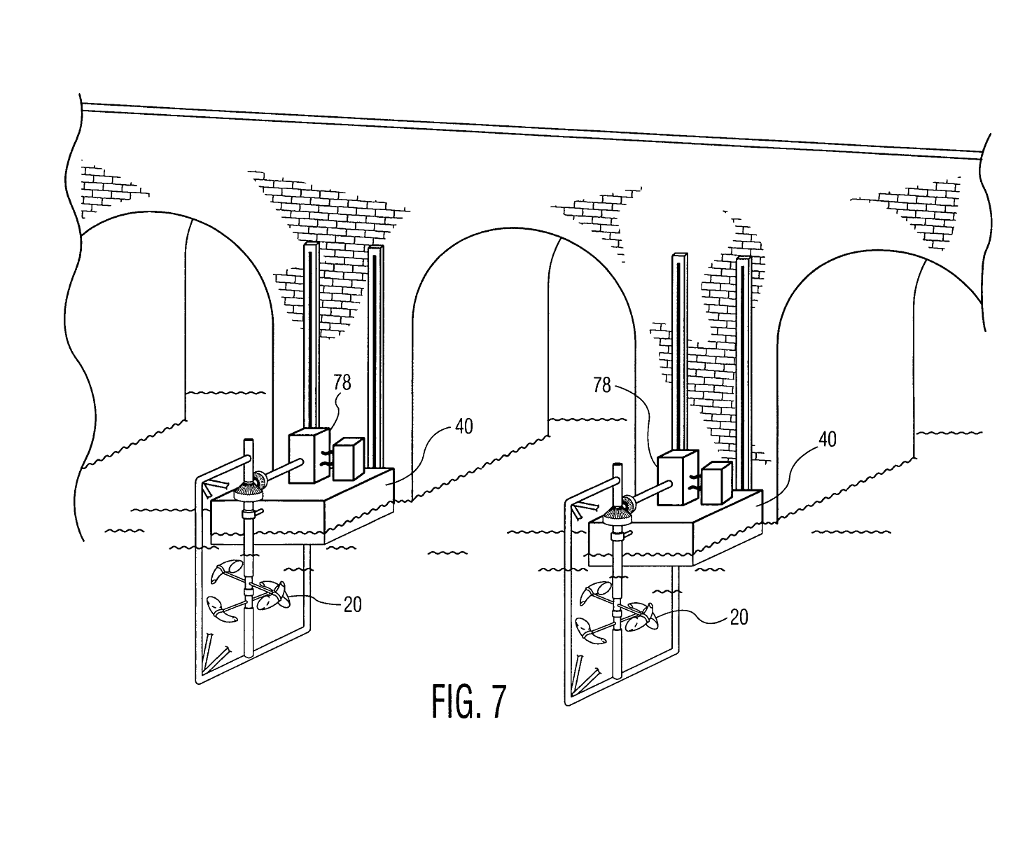

FIG. 7 is a highly simplified isometric diagram showing the placement of water flow current converters and their corresponding electric generators about the arches of bridges to capture enhanced current flow in the channels between the arches of the bridge.

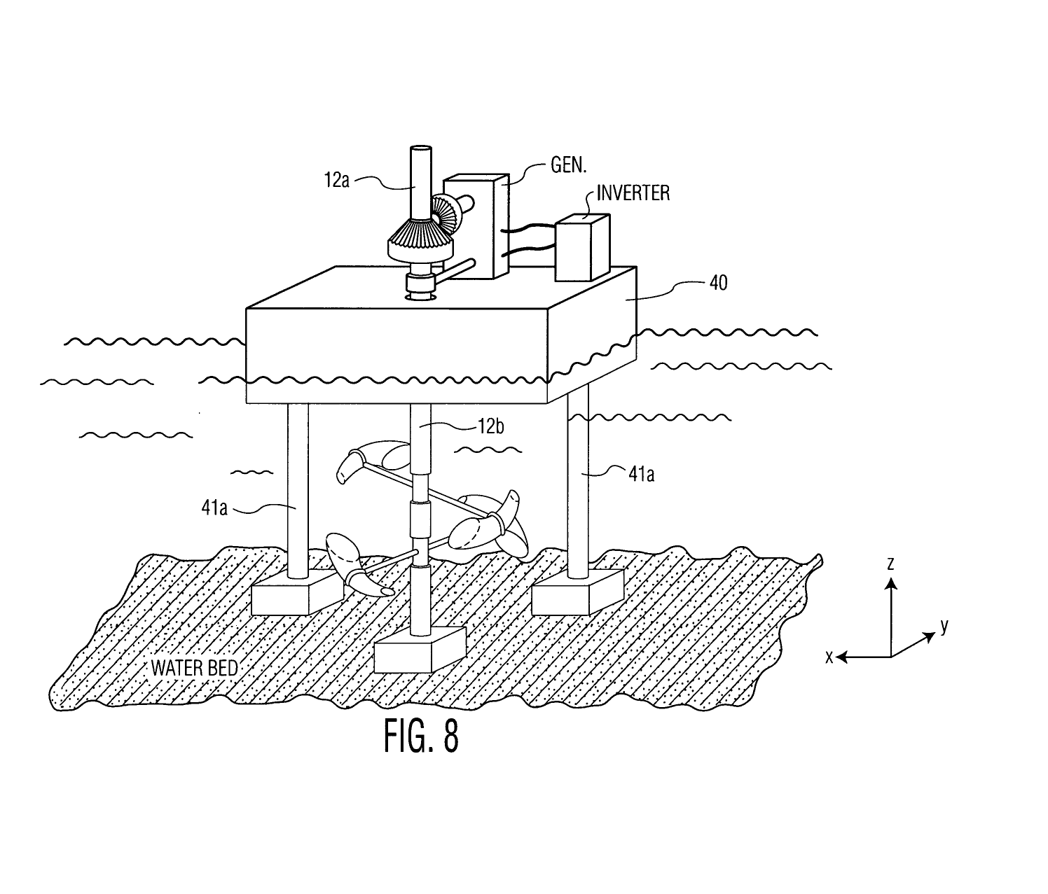

FIG. 8 is a highly simplified isometric diagram corresponding to FIG. 1C showing the central shaft of a water flow converter supported from a point on the river bed. As discussed above, where the electric generators are placed on top of a platform, the whole system can be designed rise and fall depending on the water level of the river, so that the rotary propellers system automatically adjusts their position and are always submerged.

The water current energy converters and their corresponding electric generators may be designed to produce and handle 1 KW to 500 KW (or more) depending on how big or small the river is. A gear system can be used to step up the speed of the turbines (generators) where the voltage produced by the generator is proportional to the speed at which it turns.

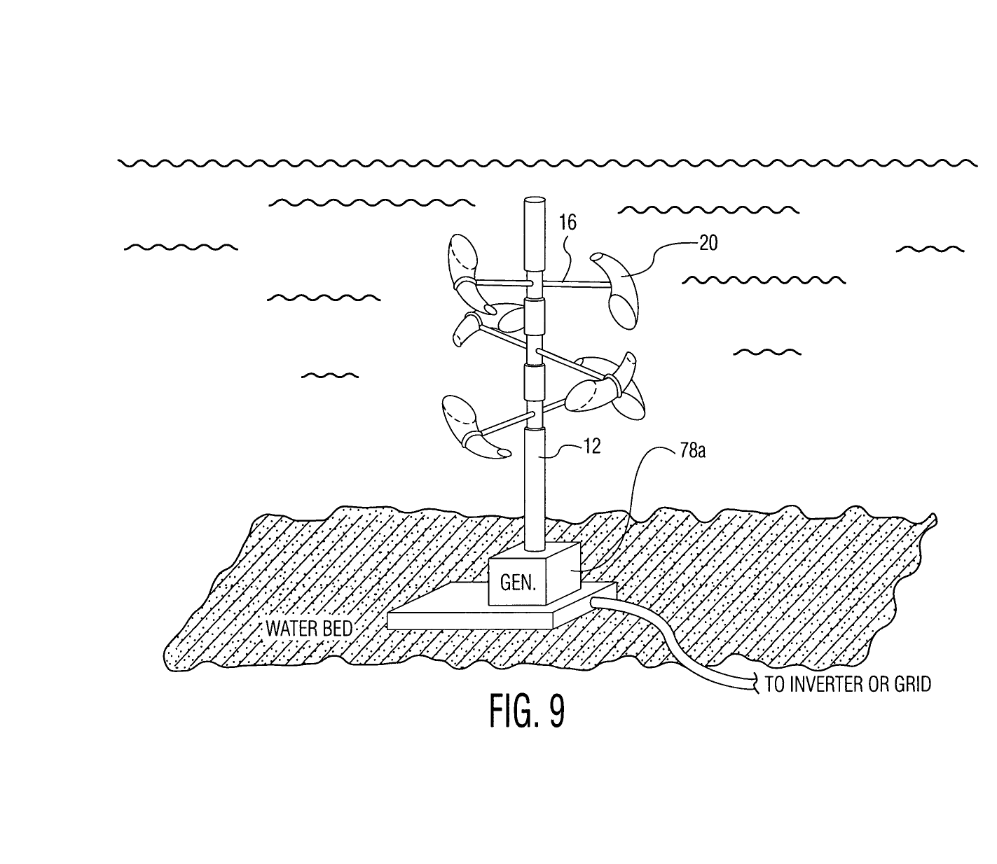

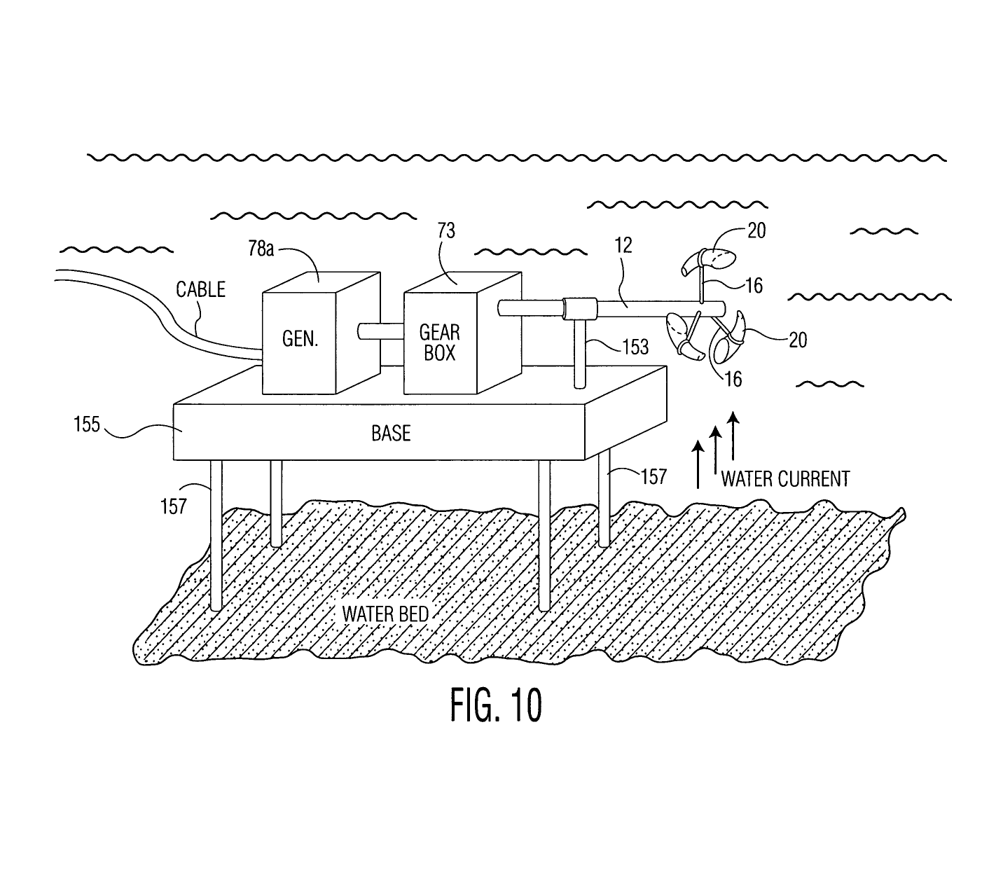

FIG. 9 is a highly simplified isometric diagram illustrating that the current flow converter can be completely submerged. In this embodiment, the central rotating shaft 12, extends vertically and is driven by arms 16 and propeller 20, and the rotating shaft is directly or indirectly coupled to a generator 78a. Generator 78a differs from generator 78 in that it is submersible and can operate under the water (i.e., it is waterproof). The operation of the current flow converter of FIG. 9 is otherwise similar to that of the non-submerged embodiments shown in the other figures. The output of the generator can be coupled via a cable to a power grid or to a submersible inverter 79a whose output can then be coupled to a power utility grid or it can be used to charge any storage element.

FIG. 10 is a highly simplified diagram showing a fully submerged water current flow converter driving an electrical generator; where the central shaft extends horizontally parallel to the river bed. The arms 16 and propellers 20 are connected to the central shaft 12 as in prior drawings, except that the central shaft is now deployed in a horizontal orientation. The shaft 12 is shown to be coupled via a gear box 73 to a waterproof, submersible, generator 78a. The central shaft is shown to be supported by support apparatus 153 resting on a base 155. The generator 78a is also shown supported by base 155. Base 155 can be raised above the river bed by means of support 157. Alternatively, base 155 may rest directly on the river bed. The operation of the system of FIG. 10 is similar to that of FIG. 9, except that the central shaft is oriented in the horizontal direction. However, the method of capturing the energy in the water current is similar to that shown and discussed in the other figures.

What is claimed is:

1. A water current energy converter comprising:
a rotatable central shaft at least a portion of which is supported and submerged below the surface of a body of water;
a water current responsive device attached to the submerged portion of the shaft for causing the shaft to rotate as a function of water current flow; said water current responsive device including a multiplicity of curved horn shaped devices connected to the rotatable shaft, each horn shaped device having a large area input end oriented to capture water current flow and having a relatively small area output end out of which water can flow, said curved horn shaped devices being propelled by said current flow to convert the water flow into a generally rotary motion for causing rotation of said rotatable central shaft; and
an electrical generator coupled to the rotatable central shaft for producing electric energy as a function of the rotation of the central shaft.

2. A water current energy converter as claimed in claim 1, wherein said water flow responsive device includes a plurality of arms attached to the portion of the vertically oriented shaft located below the water surface; said plurality of arms extending outwardly from the shaft below the surface of the water; and said multiplicity of curved horn shaped devices being connected to said plurality of arms for causing rotation of said rotatable vertically oriented shaft; and wherein said shaft is mechanically coupled to said electrical generator.

3. A water current energy converter as claimed in claim 2 wherein said curved horn shaped devices are positioned along their associated arms and are oriented such that their input ends are adapted to be filled with, and pushed by, the water current flow, whereby the arms carrying them travel in a generally horizontal circular path.

4. A water current energy converter as claimed in claim 3 wherein the arms extend in a generally perpendicular direction to the shaft and are supported by bracing diagonal struts connected between the shaft and the arms to maintain the arms steady.

5. A water current energy converter as claimed in claim 4 wherein there is one set of arms at one level along the shaft and another set of arms at another level along the shaft and wherein at least one horn shaped device is connected to each arm.

6. A water current energy converter as claimed in claim 1 wherein said rotatable central shaft extends vertically above and below the surface of said body of water; and
wherein the water flow responsive device is attached to the submerged portion of the central shaft for causing the shaft to rotate as a function of water current flow; and
wherein the electric generator is coupled to the portion of the shaft extending above the water surface for producing electric energy as a function of the rotation of the shaft, and said electric generator being held above the water surface.

7. A water current energy converter as claimed in claim 6 wherein the central shaft is connected to a platform floating along the surface of the body of water; and wherein the electric generator is mounted above the platform.

8. A water current energy converter as claimed in claim 7 wherein the platform is a boat, a pier, a wharf, a raft or a barge.

9. A water current energy converter as claimed in claim 1 wherein the central shaft is coupled via a gearing arrangement to the electric generator to increase the rotational speed of the generator.

10. A water current energy converter as claimed in claim 7 wherein the central shaft is connected to the platform so as to support the shaft and limit horizontal and vertical movement of the central shaft, while leaving it free to rotate.

11. A water current energy converter as claimed in claim 10 wherein the central shaft is supported and held in place by a structural supporting system depending from the platform for causing the shaft to move in tandem with the platform while being free to rotate.

12. A water current energy converter as claimed in claim 7 wherein the central shaft is connected to the platform so its horizontal spacing relative to the platform is held fixed, and wherein the submerged portion of the central shaft is supported from the bottom of the body of water.

13. A water current energy converter as claimed in claim 6 wherein the central shaft is connected to a platform so its horizontal displacement relative to the platform is held fixed and wherein the central shaft drives a first electric generator mounted on the platform and further including a wind turbine mounted above the platform for driving a second electric generator; and means for combining the outputs of the first and second electric generators.

14. A water current energy converter as claimed in claim 6 wherein the central shaft is connected to an inner or outer surface of a platform to support the central shaft and limit its horizontal and vertical displacement while allowing it to rotate freely.

15. A water current energy converter as claimed in claim 1, wherein each curved horn shaped device has a cross section with: (a) an outer edge which defines a relatively thin edge and from which upper and lower surfaces expand upward and downward, and (b) an inner edge which defines a relatively thin edge and from which the upper and lower surfaces expand upward and downward.

16. A water current energy converter as claimed in claim 1, wherein each curved horn shaped device has a cross section with: (a) an outer edge which defines a relatively thin edge and from which upper and lower surfaces expand upward and downward, and (b) an inner edge which defines a relatively thick edge of selected height orthogonal to the direction of the cross section for providing a surface responsive to water current flow.

17. A water current energy converter as claimed in claim 1 wherein said rotatable central shaft extends vertically, generally perpendicular to the bed of the body of water, and wherein the electric generator is a waterproof submersible device coupled to the portion of the shaft extending below the water surface for producing electric energy as a function of the rotation of the shaft.

18. A water current energy converter as claimed in claim 1 wherein said rotatable central shaft extends horizontally, generally parallel to the bed of the body of water, and wherein the electric generator is a waterproof submersible device coupled to the portion of the shaft extending below the water surface for producing electric energy as a function of the rotation of the shaft.

19. A water current energy converter comprising:
a rotatable vertically oriented shaft extending above and below the surface of a body of water;
a water flow responsive device attached to the portion of the shaft extending below the water surface for causing the shaft to rotate as a function of water current flow; and
an electric generator coupled to the portion of the shaft extending above the water surface for producing electric power as a function of the rotation of the shaft, and said electric generator being held above the water surface.

20. A water current energy converter as claimed in claim 19, wherein said water flow responsive device includes a plurality of arms attached to the portion of the vertically oriented shaft located below the water surface and extending outwardly from the shaft below the surface of the water; and a multiplicity of curved horn shaped devices connected to said plurality of arms, each horn shaped device having an input end into which water can flow and having an output end out of which water can flow, the area of the output end being a small fraction of the area at the input end; and said horn shaped devices being propelled by said current flow to convert the water flow into a generally horizontal rotary motion for causing rotation of said rotatable vertically oriented shaft; and wherein said shaft is mechanically connected to said electrical generator.

21. A water current energy converter as claimed in claim 20 wherein said horn shaped devices are positioned along their associated arms and are oriented such that their input ends are adapted to be filled with, and pushed by, the water current flow, whereby the arms carrying them travel in a generally horizontal circular path.

22. A water current energy converter as claimed in claim 20 wherein the central shaft is connected to a platform floating along the surface of the body of water;
and wherein the electric generator is mounted above the platform.

23. A water current energy converter as claimed in claim 22 wherein the vertical positioning of the central shaft is maintained by a structural supporting system depending from the platform for causing the shaft to move in tandem with the platform while being free to rotate.

24. A water current energy converter comprising:
a rotatable central shaft at least a portion of which is submerged below the surface of a body of water;
a water flow responsive device attached to the submerged portion of the shaft for causing the shaft to rotate as a function of water current flow; said water flow responsive device including a plurality of arms extending outwardly and in a general orthogonal direction relative to the shaft, and multiplicity of curved horn shaped devices connected to said plurality of arms, each horn shaped device having an input end into which water can flow and having an output end out of which water can flow, the area of the output end being a small fraction of the area at the input end; and said horn shaped devices being propelled by said current flow to convert the water flow into a generally horizontal rotary motion for causing rotation of said rotatable central shaft; and
an electrical generator coupled to the rotatable central shaft for producing electric energy as a function of the rotation of the central shaft.
